(19) United States
(12) Patent Application Publication
(10) Pub. No.: US 2008/0222975 A1
(43) Pub. Date: Sep. 18, 2008

(54) SLIDING-TYPE LAMINATED PLATE BEARING AND STRUCTURE

(75) Inventors: Yasuhiro Nakata, Tokyo (JP); Atsushi Watanabe, Tokyo (JP); Eiichiroh Saeki, Tokyo (JP)

Correspondence Address: DORSEY & WHITNEY LLP;INTELLECTUAL PROPERTY DEPARTMENT, 250 PARK AVENUE, NEW YORK, NY, 10177, US

(73) Assignee: Nippon Steel Engineering Co., Ltd., Chiyoda-ku (JP)

(21) Appl. No.: 12/047,733

(22) Filed: Mar. 13, 2008

(30) Foreign Application Priority Data
Mar. 16, 2007 (JP) 2007-69492

(51) Int. Cl. E04H 9/02; F16C 29/12

(52) U.S. Cl. 52/167.9; 384/40

(57) ABSTRACT

The sliding-type laminated plate bearing is provided with a laminated portion at which a plurality of hard rigid members and a plurality of soft elastic members are laminated alternately in a state of being wholly or partially non-adhesive, a first smooth member of which the surface is made smooth and which is in contact at least with either end face of the laminated portion in the laminated direction, and a second smooth member which is in contact with the first smooth member and which is installed so as to be slidable with respect to the first smooth member.

### CROSS-REFERENCE TO RELATED APPLICATIONS

Priority is claimed on Japanese Patent Application No. 2007-69492 filed on Mar. 16, 2007, the content of which is incorporated herein by reference.

### BACKGROUND OF THE INVENTION

1. Field of the Invention

The present invention relates to a sliding-type laminated plate bearing and a structure.

2. Description of Related Art

A seismic force acting on structures can be mitigated mainly by earthquake resistance, seismic isolation and vibration control, for each of which various methods of structural designs and applicable apparatuses have been proposed. Therefore, flexible basic structures such as a laminated rubber isolator and mechanical isolation methods such as a sliding isolator have been proposed as a seismic isolation structure.

A laminated rubber isolator is fabricated by alternately laminating rubber plates and steel plates. Since the rubber plate is held between the steel plates, it is restrained by the steel plates from being deformed so as to expand laterally on application of a vertical load to the laminated rubber isolator. Thus, no great deformation is caused. Further, since rubber is characterized by lower shear rigidity with respect to a horizontal force and can be deformed to a greater extent, structures are lengthened in period characteristics.

On the other hand, the sliding isolator is an apparatus, which is allowed to slide between an upper structure and a lower structure, thereby reducing the horizontal force when a seismic force is input. The sliding isolator is provided with an elastic sliding bearing portion at which laminated rubber plates are arranged serially and a PTFE (polytetrafluoroethylene) material is adhered to the end face of the laminated rubber plate.

Japanese Published Unexamined Patent Application No. H2-153137 and Japanese Published Unexamined Patent Application No. H6-158910 have disclosed technologies on a laminated rubber isolator. Japanese Published Unexamined Patent Application No. H9-195571 and Japanese Patent No. 3563669 have disclosed technologies on a sliding laminated rubber isolator in combination of a laminated rubber isolator with a sliding isolator.

The laminated rubber isolators disclosed in Japanese Published Unexamined Patent Application No. H2-153137 and Japanese Published Unexamined Patent Application No. H6-158910 are those in which rubber plates and steel plates are laminated in a non-adhesive state. Then, the upper part and the lower part of the laminated rubber isolator are respectively fixed to the lower construction body and the upper construction body of a structure. The laminated rubber isolators can be manufactured relatively easily. However, a problem is found that when a relatively great force, the extent of which is slightly lower than the frictional force of rubber, is applied, for example, by a seismic force to a structure in which a laminated rubber isolator is installed, the rubber plate and steel plate are locally deviated due to a relatively great horizontal deformation occurring in the laminated rubber isolator, by which the laminated rubber plate is lowered to result in inclination of the upper construction body. An other problem is that when a force greater than the frictional force of rubber is generated, for example, by a seismic force, the rubber plate and steel plate are deviated greatly and the deformation thereof still remains, by which the laminated rubber isolator is unable to retain height and shape, resulting in inclination of the upper construction body. As a result, still another problem is that a greater number man-hours are required for restoring the structure.

The laminated rubber isolator used in the sliding laminated rubber isolators disclosed in Japanese Published Unexamined Patent Application No. H9-195571 and Japanese Patent No. 3563669 is a vulcanized adhesive laminated rubber isolator. In order to manufacture the vulcanized adhesive laminated rubber isolator, a rubber plate prior to vulcanization and a steel plate are laminated and, then, subjected to heat treatment for integral molding or a molding die is required, which creates the problem of complicating the process. There is also posed such a problem that the vulcanized adhesive laminated rubber isolator is higher in manufacturing cost. Further, the isolator is heavier in weight due to the integral molding and requires large heavy machinery for installing or changing members at a construction site, which poses another problem.

The present invention has been made in view of the above problems, an object of which is to provide a novel and improved sliding-type laminated plate bearing, which can be easily adjusted for friction coefficients and increased in deformation capacity and also able to add frictional attenuation as well as to provide a structure.

### SUMMARY OF THE INVENTION

A first aspect of the sliding-type laminated plate bearing in the present invention includes: a laminated portion at which a plurality of hard rigid members and a plurality of soft elastic members are alternately laminated in a state of being wholly or partially non-adhesive; a first smooth member of which the surface is made smooth and which is in contact at least with either end face of the laminated portion in the laminated direction; and a second smooth member which is in contact with the first smooth member and which is installed so as to be slidable with respect to the first smooth member.

Input of a horizontal external force to the sliding-type laminated plate bearing of the present invention develops a frictional force between a rigid member and an elastic member. The rigid member restrains on the basis of a frictional force with the elastic member the elastic member from expanding laterally in response to a vertical force. The elastic member is able to undergo an elastic deformation in response to the horizontal external force. Further, the first smooth member slides on the second smooth member upon input of an external force.

when the rigid member arranged at either end face of the laminated portion is in contact with the first smooth member, the first friction coefficient between the first smooth member and the second smooth member may be smaller than both the second friction coefficient between the rigid member and the elastic member and the third friction coefficient between the rigid member and the first smooth member.

when the elastic member arranged at either end face of the laminated portion is in contact with the first smooth member, the first friction coefficient between the first smooth member and the second smooth member is smaller than both the second friction coefficient between the rigid member and the elastic member and the fourth friction coefficient between the elastic member and the first smooth member.

According to the present invention, the first smooth member and the second smooth member start to slide earlier than other layers between other constitution members.

The rigid member may include any steel plates, for example, a common steel plate such as structural steel and a special steel plate such as stainless steel. The elastic member may include rubber, for example, natural rubber and synthetic rubber such as butadiene rubber, urethane rubber and silicone rubber.

The first smooth member may be formed with a material containing polytetrafluoroethylene resin, ultra-high molecular weight polyester resin or polyamide resin. The second smooth member may be formed with metal material such as stainless steel, common steel, aluminum, and clad steel, or plastic material.

A lubricating agent such as fluorine resin coating or grease may be coated on the surface of the second smooth member as surface treatment for reducing the friction between the first smooth member and the second smooth member. Further, a plug portion, for example, a metal plug made of lead or tin may be inserted axially at the center of the laminated portion.

A second aspect of the sliding-type laminated plate bearing in the present invention is arranged between the upper construction body of a structure and the lower construction body for supporting the upper construction body. The second aspect of the sliding-type laminated plate bearing includes: a laminated portion at which a plurality of hard rigid members and a plurality of soft elastic members are alternately laminated in a state of being wholly or partially non-adhesive; a first smooth member of which the surface is made smooth and which is in contact at least with either end face of the upper construction body of the laminated portion or the lower construction body thereof; and a second smooth member which is firmly attached at least to either the upper construction body or the lower construction body and which is installed so as to be slidable with respect to the first smooth member while in contact with the first smooth member.

A steel member may be additionally provided between the second smooth member and the upper construction body or the lower construction body. According to the aspect, the sliding-type laminated plate bearing is supported by the steel member.

The structure of the present invention includes: an upper construction body; a lower construction body for supporting the upper construction body; and a sliding-type laminated plate bearing arranged between the upper construction body and the lower construction body; wherein, the sliding-type laminated plate bearing includes: a laminated portion at which a plurality of hard rigid members and a plurality of soft elastic members are alternately laminated in a state of being wholly or partially non-adhesive; a first smooth member of which the surface is made smooth and which is in contact at least with either end face of the upper construction body of the laminated portion or the lower construction body thereof; and a second smooth member which is firmly attached at least to either the upper construction body or the lower construction body and which is installed so as to be slidable with respect to the first smooth member while in contact with the first smooth member.

According to the present invention, it is possible to divide rigid members and elastic members of a laminated portion or the first smooth member and the second smooth member into small and light-weight components and bring them into a construction site. Therefore, they can be installed or exchanged more efficiently at the construction site. Further, since the structure is provided with a sliding-type laminated plate bearing, input of a horizontal external force to the structure generates a frictional force between the rigid member and the elastic member, by which the elastic member undergoes an elastic deformation in response to the horizontal external force, thus making it possible to absorb the external force. Further, when an external force is input, the first smooth member slides on the second smooth member. The rigid member of the sliding-type laminated plate bearing restrains on the basis of the frictional force with the elastic member the elastic member from expanding laterally in response to a vertical force.

A first aspect of the method for adjusting the sliding-type laminated plate bearing of the present invention is a method for adjusting the sliding-type laminated plate bearing provided with a laminated portion at which a plurality of hard rigid members and a plurality of soft elastic members are alternately laminated in a state of being wholly or partially non-adhesive, a first smooth member of which the surface is made smooth and which is in contact with the rigid member arranged on at least either end face of the laminated portion in the laminated direction, and a second smooth member which is in contact with the first smooth member and which is installed so as to be slidable with respect to the first smooth member. The first aspect of the method has a process in which a first friction coefficient between the first smooth member and the second smooth member, a second friction coefficient between the rigid member and the elastic member, and a third friction coefficient between the rigid member and the first smooth member are adjusted so that the first smooth member slides with respect to the second smooth member when a predetermined external force is input. According to the present invention, since a friction coefficient between the constituting members can be adjusted, it is possible to more freely determine a friction coefficient, which is related to a sliding movement between the first smooth member and the second smooth member. As a result, it is possible to provide the sliding-type laminated plate bearing higher in accuracy, in which a sliding mechanism can start to slide when an external force comes to a predetermined or greater level.

A second aspect of the method for adjusting the sliding-type laminated plate bearing of the present invention is a method for adjusting the sliding-type laminated plate bearing provided with a laminated portion at which a plurality of hard rigid members and a plurality of soft elastic members are alternately laminated in a state of being wholly or partially non-adhesive, a first smooth member of which the surface is made smooth and which is in contact with the elastic member arranged on at least either end face of the laminated portion in the laminated direction, and a second smooth member which is in contact with the first smooth member and which is installed so as to be slidable with respect to the first smooth member. The second aspect of the method has a process in which a first friction coefficient between the first smooth member and the second smooth member, a second friction coefficient between the rigid member and the elastic member, and a fourth friction coefficient between the elastic member and the first smooth member are adjusted so that the first smooth member slides with respect to the second smooth member when a predetermined external force is input.

According to the present invention, it is possible to make an easy adjustment of friction coefficients, increase the deformation capacity and add the frictional attenuation.

### BRIEF DESCRIPTION OF THE DRAWINGS

FIG. 1 is a side view showing the laminated rubber isolator of embodiment 1 in the present invention.

FIG. 2 is a side view showing an exemplified variation of the laminated rubber isolator of embodiment 1.

FIG. 3 is a side view showing an exemplified variation of the laminated rubber isolator of embodiment 1.

FIG. 4 is a side view showing an exemplified variation of the laminated rubber isolator of embodiment 1.

FIG. 5 is a side view showing motions of the laminated rubber isolator of embodiment 1.

FIG. 6 is a side view showing motions of the laminated rubber isolator of embodiment 1.

FIG. 7 is a side view showing the laminated rubber isolator of embodiment 2 in the present invention.

### DESCRIPTION OF THE PREFERRED EMBODIMENTS

Hereinafter, a detailed explanation will be given for preferred embodiment of the present invention by referring to the attached drawings. In addition, constituents having substantially the same functions in the present specification and drawings will be given the same letters or numerals and omitted from explanation.

### Constitution of Embodiment 1

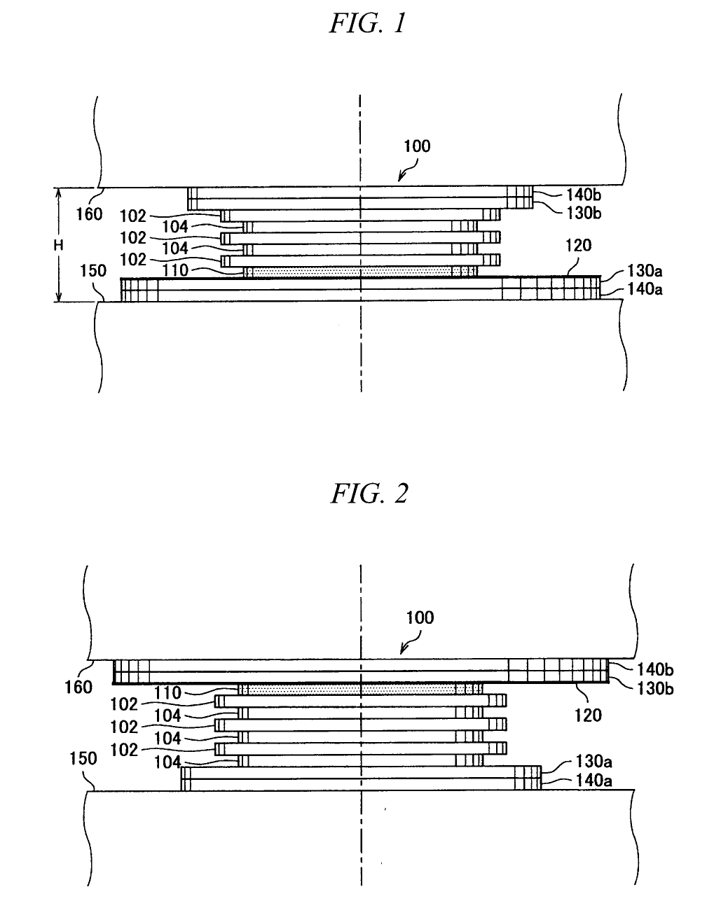

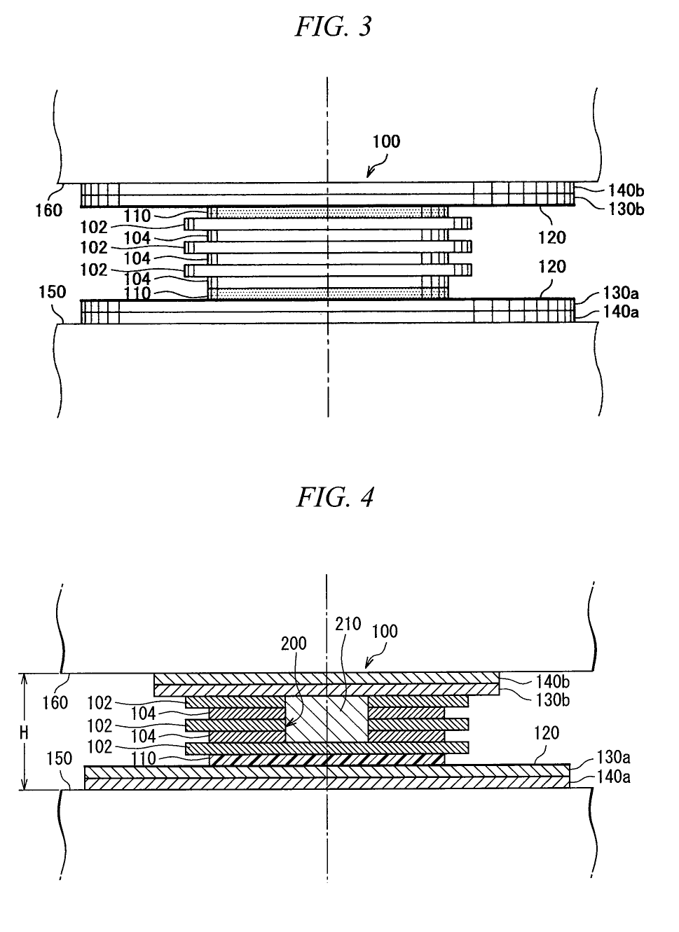

First, an explanation will be given for the constitution of the laminated rubber isolator (that is, a sliding-type laminated plate bearing) of embodiment 1 in the present invention. FIG. 1 is a side view showing the laminated rubber isolator of the present embodiment. FIG. 2 and FIG. 3 are side views showing exemplified variations of the laminated rubber isolator of the present embodiment. FIG. 1 shows an embodiment in which a PTFE plate layer 110 is installed at the lower portion. On the other hand, FIG. 2 shows an exemplified variation in which the PTFE plate layer 110 is installed at the upper side and FIG. 3 shows an exemplified variation in which the PTFE plate layer 110 is installed at the upper side and the lower side. Here, a laminated rubber isolator 100 is one example of the sliding-type laminated plate bearing.

The laminated rubber isolator 100 is provided with a steel plate layer 102, a rubber plate layer 104, a PTFE plate layer 110, a stainless steel plate layer 120, and flange portions 130a, 130b. Here, the steel plate layer 102 is one example of the rigid member, the rubber plate layer 104 is one example of the elastic member, the PTFE plate layer 110 is one example of the first smooth member, the stainless steel plate layer 120 is one example of the second smooth member, and the flange portions 130a, 130b are examples of the steel member.

The laminated rubber isolator 100 is an apparatus used in applying seismic isolation to a structure and capable of suppressing a force input externally to the structure, for example, a seismic force. The laminated rubber isolator 100 is installed on a lower construction body 150 of the structure to support an upper construction body 160. That is, the laminated rubber isolator 100 is installed between the lower construction body 150 and the upper construction body 160. Here, the structure includes building structures such as buildings and houses, civil engineering structures such as bridges and industrial structures such as plants. The lower construction body 150 includes foundations of structures and bridge piers. The upper construction body 160 includes building frames made up of floors, columns and walls, and main girders and main structures of bridges.

The lower base plate 140a and the upper base plate 140b shown in FIG. 1 to FIG. 3 are, for example, members made of a steel plate and installed by using anchor bolts so as to be integrally assembled respectively into the lower construction body 150 and the upper construction body 160. The flange portions 130a, 130b of the laminated rubber isolator 100 are jointed to the lower base plate 140a and the upper base plate 140b, for example, by using fixing screws. As a result, the laminated rubber isolator 100 is jointed to the lower construction body 150 or the upper construction body 160. In addition, the lower base plate 140a, the upper base plate 140b or the flange portions 130a, 130b are not formed as separate components but provided as a component at which the base plate and the flange portion are integrally formed at the respective upper and lower portions. Here, the laminated rubber isolator 100 is jointed to the lower construction body 150 and the upper construction body 160 via the integrally formed components installed vertically by using anchor bolts and the like.

Next, an explanation will be given in detail for each of the constitution members of the laminated rubber isolator 100.

A steel plate layer 102 is, for example, a circular plate member made of steel. The steel plate layer 102 is composed of a plurality of layers and installed so as to be held between rubber plate layers 104. FIG. 1 to FIG. 3 show the steel plate layer 102 composed of three layers, which may be changed depending on design conditions. Since the steel plate layer 102 is installed, the rubber plate layer 104 is restrained thereby from such deformation that tends to expand laterally, avoiding a great deformation even on application of a vertical load to the laminated rubber isolator 100.

The rubber plate layer 104 is a circular plate member, for example, made of vulcanized rubber. The rubber plate layer 104 is made up of a plurality of layers and installed so as to be held between the steel plate layers 102. FIG. 1 shows the rubber plate layer 104 made up of two layers, whereas FIG. 2 and FIG. 3 show the rubber plate layer 104 made up of three layers, and the number of layers may be changed depending on design conditions. The rubber plate layer 104 is lower in shear rigidity with respect to a horizontal force.

The steel plate layer 102 and the rubber plate layer 104 are laminated so as to be in contact with each other. It is, however, not necessary to adhere their opposing faces entirely with an adhesive agent and the like. For example, a laminated portion of the laminated rubber isolator 100 can be constituted simply in a state that the steel plate layer 102 is completely non-adhesive to the rubber plate layer 104. Alternatively, the steel plate layer 102 and the rubber plate layer 104 are laminated in a state of being partially adhered to such an extent that they can be separated easily. Since the laminated rubber isolator 100 of the present embodiment can be manufactured only by a simple lamination, it is possible to manufacture the isolator more quickly and easily than a vulcanized adhesive laminated rubber isolator.

Further, the steel plate layer 102 may be larger in area than the rubber plate layer 104. The steel plate layer 102 is projected from the rubber plate layer 104. Thus, where the steel plate layer 102 is broken by an external force, the soundness of the laminated rubber isolator 100 can easily be confirmed due to the fact that the steel plate layer 102 is further projected from the rubber plate layer 104.

A PTFE plate layer 110 is a plate member, for example, made of (polytetrafluoroethylene: PTFE) resin. In addition, a material smaller in friction coefficient may be used in place of the PTFE plate layer 110, and, for example, a plate member made of a synthetic resin such as ultra high molecular weight polyester resin or polyamide resin may be used. As shown in FIG. 1 to FIG. 3, the PTFE plate layer 110 is installed so as to be constantly in contact with a stainless steel plate layer 120. Further, the PTFE plate layer 110 is, for example, as shown in FIG. 1, arranged so as to be in contact with a steel plate layer 102 at the lower side of the laminated rubber isolator 100. In addition, the arrangement of the PTFE plate layer 110 is not limited to the above case and, for example, as shown in FIG. 2, the PTFE plate layer 110 may be arranged so as to be in contact with the steel plate layer 102 at the upper side of the laminated rubber isolator 100. Still further, as shown in FIG. 3, the PTFE plate layer 110 may be arranged so as to be in contact with the rubber plate layer 104.

The stainless steel plate layer 120 is a plate member made of, for example, stainless steel. In addition, the other plate member, having appropriate strength, may be replaced instead of the stainless steel member. As the material used to form the other plate member, a metal material such as common steel, aluminum, and clad steel, or a plastic material may be utilized. As shown in FIG. 1 to FIG. 3, the stainless steel plate layer 120 is arranged so as to be in contact with the PTFE plate layer 110. Further, as shown in FIG. 1 to FIG. 3, the stainless steel plate layer 120 is fixed to flange portions 130a, 130b. In addition, in order to reduce the frictional force resulting from the PTFE plate layer 110, the surface of the stainless steel plate layer 120 may be subjected to surface treatment. As the surface treatment, a coating, an adhesion or baking of a low friction material such as fluorine resin containing paint, or a coating of grease may be utilized. As the fluorine resin containing paint, PTFE or the like may be utilized.

The flange portions 130a, 130b are, for example, steel-made plate members. The flange portion 130b is, for example, as shown in FIG. 1, connected to the steel plate layer 102 at the upper side of the laminated rubber isolator 100. The flange portion 130b is jointed to the steel plate layer 102, for example, on welding or by using bolts. In addition, a relationship in which the flange portions 130a, 130b on the upper and lower sides of the laminated rubber isolator 100 are in contact with the steel plate layer 102 and the rubber plate layer 104 is not limited to the case shown in FIG. 1. For example, as shown in FIG. 2, the rubber plate layer 104 may be installed so as to be in contact with the flange portion 130a on the lower side of the laminated rubber isolator 100. Further, the stainless steel plate layer 120 is installed at least on one of the upper and the lower sides of the laminated rubber isolator 100 at the flange portions 130a, 130b.

In addition, as shown in FIG. 4, a cylindrical through hole 200 is provided at the center of the thus laminated steel plate layer 102 and the rubber plate layer 104. A plug portion 210 made of metal such as lead or tin may be inserted into the through hole 200. The plug portion 210 functions as an energy absorbing damper. Further, in the present embodiment, since slippage occurs between the PTFE plate layer 110 and the stainless steel plate layer 120, the steel plate layer 102 and the rubber plate layer 104 are deformed to a smaller extent than a laminated rubber isolator free of a sliding mechanism. Therefore, the present embodiment does not require the plug portion 210 to undergo a great deformation.

Next, an explanation will be made for establishing the respective friction coefficients between the PTFE plate layer 110, the stainless steel plate layer 120, the steel plate layer 102 and the rubber plate layer 104 shown in FIG. 1 and FIG. 2. The friction coefficient between the PTFE plate layer (corresponding to a first smooth member of the present invention) 110 and the stainless steel plate layer (corresponding to a second smooth member of the present invention) 120 is given as μ1 (first friction coefficient), the friction coefficient between the steel plate layer (corresponding to a rigid member of the present invention) 102 and the rubber plate layer (corresponding to a elastic member of the present invention) 104 is given as μ2 (second friction coefficient), and the friction coefficient between the PTFE plate layer 110 and the steel plate layer 102 is given as μ3 (third friction coefficient). Further, a friction coefficient between the PTFE plate layer 110 and the rubber plate layer 104 shown in FIG. 3 is given as μ4 (fourth friction coefficient).

In the present embodiment, the friction coefficient μ1 is established so as to be smaller than the friction coefficients μ2, μ3 and μ4. Since the friction coefficient μ1 between the PTFE plate layer 110 and the stainless steel plate layer 120 is established to be smaller than friction coefficients between other layers, a sliding movement between the PTFE plate layer 110 and the stainless steel plate layer 120 occurs, when a horizontal force greater than a predetermined force, for example, a seismic force, is input to the laminated rubber isolator 100. On occurrence of the sliding movement, such an external force causing another sliding movement between other layers will not be input any more. Thus, there is no chance that any sliding movement is caused between the PTFE plate layer 110 and the steel plate layer 102 or between the steel plate layer 102 and the rubber plate layer 104. As a result, although the PTFE plate layer 110, the steel plate layer 102 and the rubber plate layer 104 are not adhered to each other, the friction coefficients are established and managed as described above, by which the PTFE plate layer 110, the steel plate layer 102 and the rubber plate layer 104 can be retained integrally even when a seismic force greater than a predetermined force is input.

Further, according to the present embodiment, the PTFE plate layer 110, the stainless steel plate layer 120, the steel plate layer 102 and the rubber plate layer 104 are laminated in a state of being adhesive or non-adhesive with each other, by which the friction coefficients μ2, μ3 and μ4 can be given arbitrarily. As a result, the laminated rubber isolator 100 can be designed or manufactured more accurately so that a sliding movement can be started between the PTFE plate layer 110 and the stainless steel plate layer 120 when an external force comes to a predetermined or greater level.

### Behavior of Embodiment 1

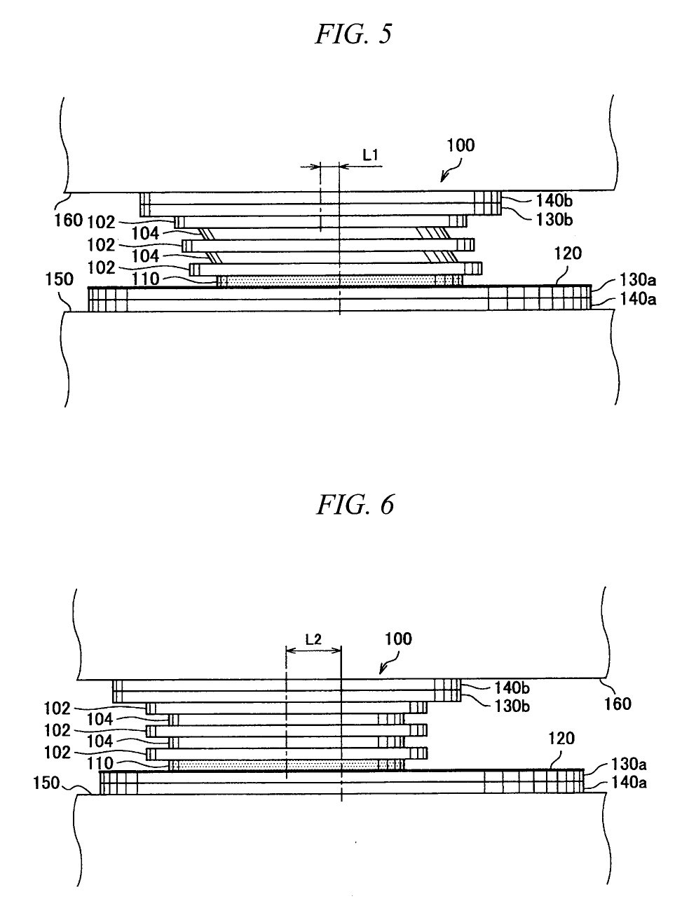

Next, an explanation will be given for behavior of the laminated rubber isolator 100 of the present embodiment when an external force such as a seismic force is input into the laminated rubber isolator. FIG. 5 and FIG. 6 are side views showing the behavior of the laminated rubber isolator of the present embodiment. The constitution of the laminated rubber isolator 100 given in FIG. 5 and FIG. 6 is the same as that of the laminated rubber isolator 100 given in FIG. 1.

At the occurrence of a small or medium-sized earthquake, the rubber plate layer 104 undergoes an elastic deformation, thereby allowing the laminated rubber isolator 100 to incline as shown in FIG. 5, and vibrating a structure. The rubber plate layer 104 is elastically deformed to lengthen the period characteristics, thus making it possible to reduce the seismic force. FIG. 5 shows a state in which the upper side of the laminated rubber isolator 100 is moved only by a length L1 from its original position. Here, since a frictional force between the PTFE plate layer 110 and the stainless steel plate layer 120 on the basis of the friction coefficient μ1 is greater than the seismic force, no sliding movement (slippage) is caused between the PTFE plate layer 110 and the stainless steel plate layer 120.

On the other hand, at the occurrence of a major earthquake, since a seismic force is greater than a frictional force between the PTFE plate layer 110 and the stainless steel plate layer 120 on the basis of the friction coefficient μ1, a sliding movement between the PTFE plate layer 110 and the stainless steel plate layer 120 occurs. However, due to the fact that the friction coefficients μ2, μ3 and μ4 are greater than μ1, no sliding movement between the steel plate layer 102 and the rubber plate layer 104 occurs. Then, the steel plate layer 102 and the rubber plate layer 104 laminated at a higher position than the PTFE plate layer 110 are allowed to slide integrally together with the upper construction body 160. FIG. 6 shows a state that each of the constitution members at a higher position than the PTFE plate layer 110 of the laminated rubber isolator 100 and the upper construction body 160 are allowed to slide only by a length L2 from their original positions.

As described above, at the occurrence of a major earthquake, a sliding movement between the PTFE plate layer 110 and the stainless steel plate layer 120 occurs, thereby the laminated rubber isolator 100 absorbs the seismic force and also consumes the energy by friction, thus making it possible to reduce the seismic force. Further, according to the present embodiment, since the friction coefficient μ1 is smaller than the friction coefficients μ2, μ3 and μ4, the sliding movement occurs first between the PTFE plate layer 110 and the stainless steel plate layer 120 to prevent the steel plate layer 102 from deviating from the rubber plate layer 104. As a result, the laminated rubber isolator 100 of the present embodiment is able to maintain the same width H after the occurrence of an earthquake (refer to FIG. 1).

Therefore, according to the laminated rubber isolator 100 of the present embodiment, the steel plate layer 102 and the rubber plate layer 104 may only be laminated in a state of being non-adhesive or partially adhesive and eliminating the need for thermal treatment for vulcanization or molding dies unlike a vulcanized adhesive laminated rubber isolator, thus making it possible to simplify manufacturing facilities and processes. Then, where as the vulcanization takes more than half a day or longer, the present embodiment is able to reduce time and costs related to manufacture. Further, since the vulcanized adhesive laminated rubber isolator is provided with steel plate layers and rubber plate layers, which are integrally formed, the extent of deformation on input of an external force is limited to the deformation capacity of rubber. However, the laminated rubber isolator 100 of the present embodiment is provided with a sliding mechanism made up of the PTFE plate layer 110 and the stainless steel plate layer 120, thus making it possible to give a greater deformation allowance.

Further, since the sliding mechanism is able to give a greater deformation allowance, in applying the laminated rubber isolator 100 of the present embodiment to a seismic isolation structure, the number of steel plate layers 102 and that of rubber plate layers 104 can be reduced, as compared with a vulcanized adhesive laminated rubber isolator. As a result, it is possible to keep the height H of the laminated rubber isolator 100 (refer to FIG. 1) lower. Thus, the laminated rubber isolator 100 can be installed at a shallow position as compared with conventional isolators to reduce installation costs.

More specifically, where a required horizontal deformation is 900 mm, the total thickness of rubber plate layers will be 225 mm for a conventional vulcanized adhesive rubber isolator, on the assumption that a limited shear strain is 400%. Further, the total thickness of the layers will be 300 mm for a conventional simple laminated rubber isolator on the assumption that the limited shear strain is 300%. On the other hand, according to the present embodiment, a limited horizontal deformation is not restricted by the shear strain of rubber. Accordingly, a total thickness of the rubber plate layers 104 is not dependent on a required horizontal deformation and allowed to be thinner than conventional counterparts.

Further, a conventional sliding isolator free of a laminated rubber isolator is higher in horizontal rigidity at an area where only a slight deformation takes place at the occurrence of a small or medium-sized earthquake, thus resulting in a case of a greater acceleration response. Therefore, the sliding isolator has difficulty in following the rotation of a foundation on input of an external force, thus creating the concern that the sliding isolator will contact the foundation at different contact pressures to break the foundation and the sliding isolator. On the other hand, because the present embodiment is provided with a steel plate layer 102 and the rubber plate layer 104, in addition to a sliding mechanism, it has a lower horizontal rigidity. Further, because the present embodiment is provided with the rubber plate layer 104, it is able to follow the rotation of the foundation and will not result in the breakage of the foundation or the laminated rubber isolator 100.

Still further, a conventional roller bearing is smaller in contact pressure allowance and tends to be larger in size when assembled into an apparatus. However, the laminated rubber isolator 100 of the present embodiment is able to make the apparatus smaller, thus reducing manufacturing and installation costs.

Then, a conventional simple laminated rubber isolator in which steel plate layers and rubber plate layers are only simply laminated, without the PTFE plate layer 110 or the stainless steel plate layer 120, will not require vulcanization or adhesion, as with the present embodiment. However, there is a problem that in the simple laminated rubber isolator, a rubber plate is locally deviated from a steel plate due to a relatively large horizontal deformation found in the laminated rubber isolator on the occurrence of a relatively large force, which is slightly lower than the frictional force of rubber, and P-δ behaviors are become unstable causing subduction in the vertical direction. Further, where the shear strain of rubber is greatly deformed to about 300%, for example, under contact pressure of about 10 MPa, the steel plate layer is greatly deviated from the rubber plate layer. When such a deviation takes place once, great costs are required to restore a structure due to the inability to restore an original configuration.

On the other hand, the laminated rubber isolator 100 of the present embodiment is provided with a sliding mechanism made up of the PTFE plate layer 110 and the stainless steel plate layer 120. Therefore, on a great deformation, the steel plate layer 102 and the rubber plate layer 104 will slide integrally with the upper construction body 160 when constituted as given in FIG. 1, and slide integrally with the lower construction body 150 when constituted as given in FIG. 2. As a result, the laminated rubber isolator 100 of the present embodiment is greatly increased in deformation capacity as compared with a conventional simple laminated rubber isolator. Further, the rubber plate layer 104 can be suppressed for shearing deformation to a predetermined or lower level, thereby preventing the occurrence of subduction in the vertical direction. Then, the laminated rubber isolator 100 is stable in P-δ behavior and provided with a stable loading endurance.

As described above, the laminated rubber isolator 100 of the present embodiment is able to easily adjust friction coefficients, with manufacturing costs reduced, improve the deformation capacity on input of an external force, and also add frictional attenuation.

Explanations have been given for preferred embodiments of the present invention by referring to the attached drawings. As a matter of course, the present invention shall not be limited to these embodiments. It is apparent that various exemplified variations and modifications can be made by those skilled in the art without departing from the claims of the patent and shall be construed to fall into the technical scope of the present invention.

For example, in the above embodiment, an explanation was given for motions and effects of the laminated rubber isolator 100 where the PTFE plate layer 110 and the stainless steel plate layer 120 are installed at the lower side of the laminated rubber isolator 100 given in FIG. 1. It is also true for the motions and effects where the PTFE plate layer 110 and the stainless steel plate layer 120 are installed at the upper side of the laminated rubber isolator 100 given in FIG. 2 or at the upper and the lower sides of the laminated rubber isolator 100 given in FIG. 3. In addition, in the laminated rubber isolator 100 given in FIG. 3, the steel plate layer 102 and the rubber plate layer 104 held between the two upper and lower PTFE plate layers 110 will behave independently of one or both of the lower construction body 150 and the upper construction body 160, when a great external force is input, for example, at the occurrence of a major earthquake.

### Constitution of Embodiment 2

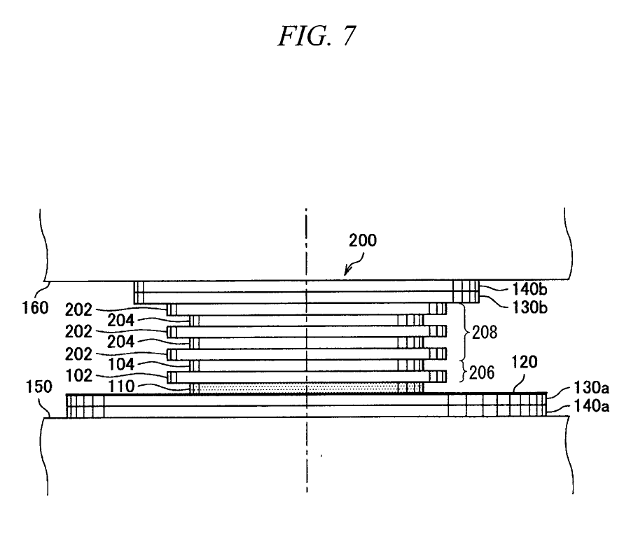

Next, an explanation will be given for the constitution of the laminated rubber isolator (that is, the sliding-type laminated plate bearing) of embodiment 2 in the present invention. FIG. 7 is a side view showing the laminated rubber isolator of the present embodiment. Also, components already explained in the above-described embodiment 1 are given the same reference numerals, and overlapping descriptions thereof are omitted.

The laminated rubber isolator 200 is provided with a steel plate layer 102, a rubber plate layer 104, a PTFE plate layer 110, a stainless steel plate layer 120, a steel plate layer 202 (corresponding to a rigid member of the present invention), a rubber plate layer 204 (corresponding to an elastic member of the present invention), and flange portions 130a, 130b.

The laminated rubber isolator 200 is composed of a simple laminated rubber section 206 and a vulcanized adhesive laminated rubber section 208. Similarly to the embodiment 1, the simple laminated rubber section 206 is constituted simply in a state that the steel plate layer 102 is completely non-adhesive to the rubber plate layer 104. Alternatively, the steel plate layer 102 and the rubber plate layer 104 are laminated in a state of being partially adhered to such an extent that they can be separated easily. FIG. 7 shows each of the steel plate layer 102 and the rubber plate layer 104 made up of one layer. However, the number of layers may be changed depending on design conditions.

The vulcanized adhesive laminated rubber section 208 is constituted so that the steel plate layers 202 and the rubber plate members 204 are fixed so as to be in contact with each other by vulcanization. The steel plate layer 202 is a circular member, and for example, is made of steel plate. The steel plate layer 202 is made of a plurality of layers and installed so as to be held between the rubber plate layers 204. FIG. 7 shows the steel plate layer 202 made up of three layers, and the number of layers may be changed depending on design conditions. Since the steel plate layer 202 is installed, the rubber plate layer 204 is restrained thereby from such deformation that tends to expand laterally, avoiding a great deformation even on application of a vertical load to the vulcanized adhesive laminated rubber section 208. The rubber plate layer 204 is a circular member, for example, is made of vulcanized rubber. The rubber plate layer 204 is made of a plurality of layers and installed so as to be held between the steel plate layers 202. FIG. 7 shows the rubber plate layer 204 made up of two layers. However, the number of layers may be changed depending on design conditions. The rubber plate layer 204 is lower in shear rigidity with respect to a horizontal force. The steel plate layers 202 are entirely adhered to the rubber plate members 204 so as to be in contact with each other by vulcanization.

In the present embodiment, the friction coefficient between the steel plate layer 202 located at the bottom of the vulcanized adhesive laminated rubber section 208 and the rubber plate layer 104 located at the top of the simple laminated rubber section 206 is given as μ2 (second friction coefficient) the same as the friction coefficient between the steel plate layer 102 and the rubber plate layer 104.

### Behavior of Embodiment 2

Next, an explanation will be given for the behavior of the laminated rubber isolator 200 of the present embodiment when an external force such as a seismic force is input into the laminated rubber isolator.

At the occurrence of a small or medium-sized earthquake, the rubber plate layer 104 and the rubber plate layer 204 undergo an elastic deformation, thereby allowing the laminated rubber isolator 200 to incline, and vibrating a structure. The rubber plate layer 104 and the rubber plate layer 204 are elastically deformed to lengthen the period characteristics, thus making it possible to reduce the seismic force. Here, since the frictional force between the PTFE plate layer 110 and the stainless steel plate layer 120 on the basis of the friction coefficient μ1 is greater than the seismic force, no sliding movement (slippage) is caused between the PTFE plate layer 110 and the stainless steel plate layer 120.

On the other hand, at the occurrence of a major earthquake, since a seismic force is greater than a frictional force between the PTFE plate layer 110 and the stainless steel plate layer 120 on the basis of the friction coefficient μ1, a sliding movement between the PTFE plate layer 110 and the stainless steel plate layer 120 occurs. However, due to the fact that the friction coefficients μ2 and μ3 are greater than μ1, no sliding movement between the steel plate layer 102 and the rubber plate layer 104 occurs. Similarly, no sliding movement between the steel plate layer 202 and the rubber plate layer 104 occurs. Then, the simple rubber laminated section 206 and the vulcanized adhesive laminated rubber section 208 laminated at a higher position than the PTFE plate layer 110 are allowed to slide integrally together with the upper construction body 160.

As described above, at the occurrence of a major earthquake, the sliding movement between the PTFE plate layer 110 and the stainless steel plate layer 120 occurs, thereby the laminated rubber isolator 200 absorbs the seismic force and also consumes the energy by friction, thus making it possible to reduce the seismic force. Further, according to the present embodiment, since the friction coefficient μ1 is smaller than the friction coefficients μ2 and μ3, the sliding movement occurs first between the PTFE plate layer 110 and the stainless steel plate layer 120 to prevent the steel plate layer 102 from deviating from the rubber plate layer 104 and to prevent the steel plate layer 202 from deviating from the rubber plate layer 204. As a result, the laminated rubber isolator 200 of the present embodiment is able to maintain the same width after the occurrence of an earthquake.

Therefore, according to the laminated rubber isolator 200 of the present embodiment, the steel plate layer 102 and the rubber plate layer 104 which form of the simple laminated rubber section 206 may only be laminated in a state of being non-adhesive or partially adhesive. Further, the vulcanized adhesive laminated rubber section of the laminated rubber isolator 200 is smaller than a conventional vulcanized adhesive laminated rubber isolator. Therefore, it is possible to simplify manufacturing facilities and processes of the isolator. Furthermore, since the conventional vulcanized adhesive laminated rubber isolator is provided with steel plate layers and rubber plate layers, which are integrally formed, the extent of deformation on input of an external force is limited to the deformation capacity of rubber. However, the laminated rubber isolator 200 of the present embodiment is provided with a sliding mechanism made up of the PTFE plate layer 110 and the stainless steel plate layer 120, thus making it possible to give a greater deformation allowance.

Further, since the sliding mechanism is able to give a greater deformation allowance, in applying the laminated rubber isolator 200 of the present embodiment to a seismic isolation structure, the entire number of layers included in the laminated portion can be reduced as compared with the conventional vulcanized adhesive laminated rubber isolator. The number of entire layers included in the laminated portion is made of the number of layers of the simple laminated rubber section 206 composed of the steel plate layer 102 and the rubber plate layer 104 and the number of layers of the vulcanized adhesive laminated rubber section 208 compose of the steel plate layer 202 and the rubber plate layer 204. As a result, it is possible to keep the width of the laminated rubber isolator 200 lower. Thus, the laminated rubber isolator 200 can reduce installation costs.

In the present embodiment, the PTFE plate layer 110 is installed at the lower side of the laminated rubber isolator 200. However, the PTFE plate layer 110 may be installed at the upper side of the laminated rubber isolator 200. In addition, the PTFE plate layers 110 may be installed at the upper and lower sides of the laminated rubber isolator 200.

What is claimed is:

1. A sliding-type laminated plate bearing comprising:
a laminated portion at which a plurality of hard rigid members and a plurality of soft elastic members are alternately laminated in a state of being wholly or partially non-adhesive;
a first smooth member of which the surface is made smooth and which is in contact at least with either end face of the laminated portion in the laminated direction; and
a second smooth member which is in contact with the first smooth member and which is installed so as to be slidable with respect to the first smooth member.

2. The sliding-type laminated plate bearing according to claim 1, wherein
when the rigid member arranged at either end face of the laminated portion is in contact with the first smooth member, the first friction coefficient between the first smooth member and the second smooth member is smaller than both the second friction coefficient between the rigid member and the elastic member and the third friction coefficient between the rigid member and the first smooth member.

3. The sliding-type laminated plate bearing according to claim 1, wherein
when the elastic member arranged at either end face of the laminated portion is in contact with the first smooth member, the first friction coefficient between the first smooth member and the second smooth member is smaller than both the second friction coefficient between the rigid member and the elastic member and the fourth friction coefficient between the elastic member and the first smooth member.

4. The sliding-type laminated plate bearing according to any one of claims 1 to 3, wherein the rigid member is a steel plate.

5. The sliding-type laminated plate bearing according to any one of claims 1 to 3, wherein the elastic member is made of rubber.

6. The sliding-type laminated plate bearing according to any one of claims 1 to 3, wherein the first smooth member is formed with a material containing polytetrafluoroethylene resin, ultra-high molecular weight polyester resin or polyamide resin.

7. The sliding-type laminated plate bearing according to any one of claims 1 to 3, wherein the second smooth member is made of metal or plastic.

8. The sliding-type laminated plate bearing according to any one of claims 1 to 3, wherein surface treatment is given to the surface of the second smooth member for reducing the friction between the first smooth member and the second smooth member.

9. The sliding-type laminated plate bearing according to any one of claims 1 to 3, wherein a plug portion is inserted axially at the center of the laminated portion.

10. A sliding-type laminated plate bearing arranged between the upper construction body of a structure and the lower construction body for supporting the upper construction body, comprising:
a laminated portion at which a plurality of hard rigid members and a plurality of soft elastic members are alternately laminated in a state of being wholly or partially non-adhesive;
a first smooth member of which the surface is made smooth and which is in contact at least with either end face of the upper construction body of the laminated portion or the lower construction body thereof; and
a second smooth member which is firmly attached at least to either the upper construction body or the lower construction body and which is installed so as to be slidable with respect to the first smooth member while in contact with the first smooth member.

11. The sliding-type laminated plate bearing according to claim 9, further comprising a steel member which is arranged between the second smooth member and the upper construction body or between the second smooth member and the lower construction body.

12. A structure comprising:
an upper construction body;
a lower construction body for supporting the upper construction body; and
a sliding-type laminated plate bearing arranged between the upper construction body and the lower construction body; wherein
the sliding-type laminated plate bearing comprises:
a laminated portion at which a plurality of hard rigid members and a plurality of soft elastic members are alternately laminated in a state of being wholly or partially non-adhesive;
a first smooth member of which the surface is made smooth and which is in contact at least with either end face of the upper construction body of the laminated portion or the lower construction body thereof; and
a second smooth member which is firmly attached at least to either the upper construction body or the lower construction body and which is installed so as to be slidable with respect to the first smooth member while in contact with the first smooth member.

13. A method for adjusting the sliding-type laminated plate bearing provided with a laminated portion at which a plurality of hard rigid members and a plurality of soft elastic members are alternately laminated in a state of being wholly or partially non-adhesive, a first smooth member of which the surface is made smooth and which is in contact with the rigid member arranged on at least either end face of the laminated portion in the laminated direction, and a second smooth member which is in contact with the first smooth member and which is installed so as to be slidable with respect to the first smooth member, wherein
the method has a process in which a first friction coefficient between the first smooth member and the second smooth member, a second friction coefficient between the rigid member and the elastic member, and a third friction coefficient between the rigid member and the first smooth member are adjusted so that the first smooth member slides with respect to the second smooth member when a predetermined external force is input.

14. A method for adjusting the sliding-type laminated plate bearing provided with a laminated portion at which a plurality of hard rigid members and a plurality of soft elastic members are alternately laminated in a state of being wholly or partially non-adhesive, a first smooth member of which the surface is made smooth and which is in contact with the elastic member arranged on at least either end face of the laminated portion in the laminated direction, and a second smooth member which is in contact with the first smooth member and which is installed so as to be slidable with respect to the first smooth member, wherein
the method has a process in which a first friction coefficient between the first smooth member and the second smooth member, a second friction coefficient between the rigid member and the elastic member, and a fourth friction coefficient between the elastic member and the first smooth member are adjusted so that the first smooth member slides with respect to the second smooth member when a predetermined external force is input.
